(19) United States
(12) Patent Application Publication
(10) Pub. No.: US 2005/0108580 A1
(43) Pub. Date: May 19, 2005

(54) Uninterruptible power supply with mouse pad

(76) Inventor: Yu-Lin Chung, Taipei (TW)

Correspondence Address: BACON & THOMAS, PLLC, 625 SLATERS LANE, FOURTH FLOOR, ALEXANDRIA, VA, 22314, US

(21) Appl. No.: 10/715,354

(22) Filed: Nov. 19, 2003

(51) Int. Cl. G06F 1/26

(52) U.S. Cl. 713/300

(57) ABSTRACT

The invention herein relates to a mouse pad with an uninterrupted DC supply including a battery charging circuit, a test circuit, a voltage increase circuit and a rechargeable battery, which are supplied from an external AC/DC power converter to provide recharging of the battery therein while concomitantly supplying the needs for power of a notebook, desktop computer or other compatible products. In case of city power cutoff, the mouse pad will immediately activate the battery therein to supply the needs of connected peripheral, which will then experience no disruption in power supply and, thereby, can be used for extended working hours.

### BACKGROUNG OF THE INVENTION

a) Field of the Invention

The invention herein relates to a mouse pad performing the function of an UPS (Uninterruptible Power Supply); more specifically, in case of city power supply cutoff, the mouse pad will instantly activate an inner battery in order to provide electricity to a computer or any compatible peripheral, which can then operate for an extended time.

b) Description of the Prior Art

Conventional mouse pads only have a single function, namely to provide a mouse with a surface where to glide. In other respects, electricity suppliers such as uninterruptible power system or power source also perform only one function. The user has to buy and install additional items in order to get all functions. Moreover, such systems are very heavy, bulky and uneasily movable so they don't meet the travelers' needs.

### SUMMARY OF THE INVENTION

The invention herein consists in a mouse pad, which can be connected with an AC/DC (Alternating Current/Direct Current) power converter and is opened to compatible peripherals such as notebook or desktop computer. When city-power is fully supplied, the AC/DC power converter will charge an inner battery of the mouse pad and supply power to connected peripherals at the same time. In case of city power cutoff, the mouse pad will immediately activate the rechargeable battery therein to supply the needs of connected peripheral.

Therefore, the primary objective of the invention herein is to offer a movable mouse pad device providing UPS and connectible to any system or apparatus that can be powered by a battery such as a notebook or desktop computer, thereby making them utilizable even where there is no city power supplied or in case of city power cut off.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a process diagram of the invention herein.

FIG. 2 is a process diagram of the battery charging circuit of the invention.

FIG. 3 is a process diagram of the test circuit of the invention.

FIG. 4 is a process diagram of the voltage increase circuit of the invention.

### DETAILED DESCRIPTION OF THE PREFERRED EMBODIMENTS

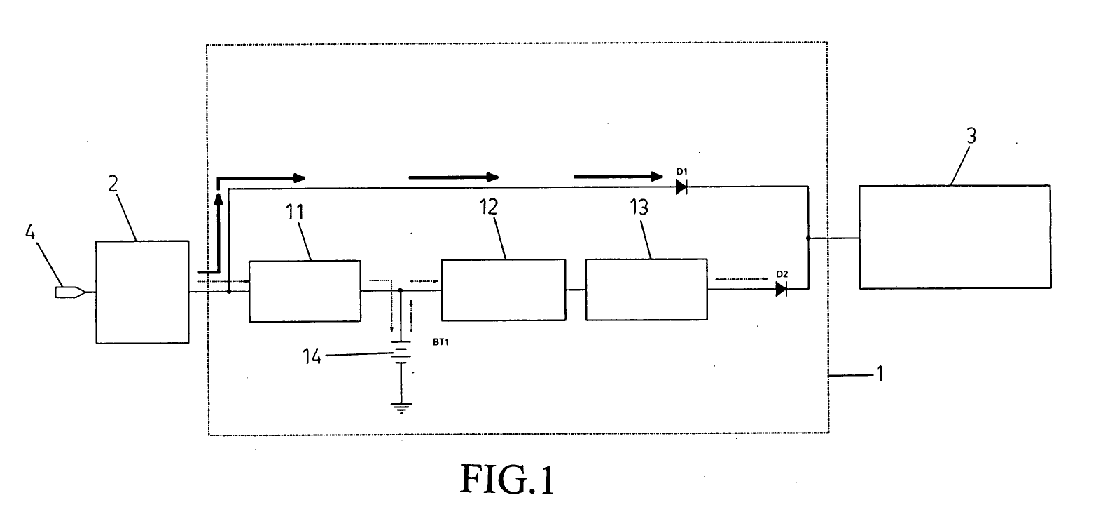

Referring to FIG. 1, the invention mainly consists of a mouse pad 1 wherein comprising a battery charging circuit 11, a test circuit 12, a voltage increase circuit 13 and a rechargeable battery 14. One end of the mouse pad 1 is connected to an AC/DC power converter 2, while the other end thereof is open in connection with a compatible peripheral 3 such as a notebook or desktop computer as well as any other system or apparatus which can be power-supplied with DC. When city power 4 is supplied in usual way, the AC/DC power converter 2 will charge the rechargeable battery 14 of the mouse pad 1 therein and, at the same time, supply the peripheral 3 with power. When city power 4 is cut off, the mouse pad 1 will immediately activate the rechargeable battery 14 herein to supply the needs of the peripheral 3, thereby allowing no disruption of power supply to the peripheral 3 and extending the span of use thereof.

Referring to FIG. 2, the mouse pad 1 is configured with the battery charging circuit 11 wherein holding a voltage-stabilizing charging circuit 111. A DC input 21 from the AC/DC power converter 2 passes through the battery charging circuit 11, resulting in a battery charging voltage output 112 comes out wherefrom.

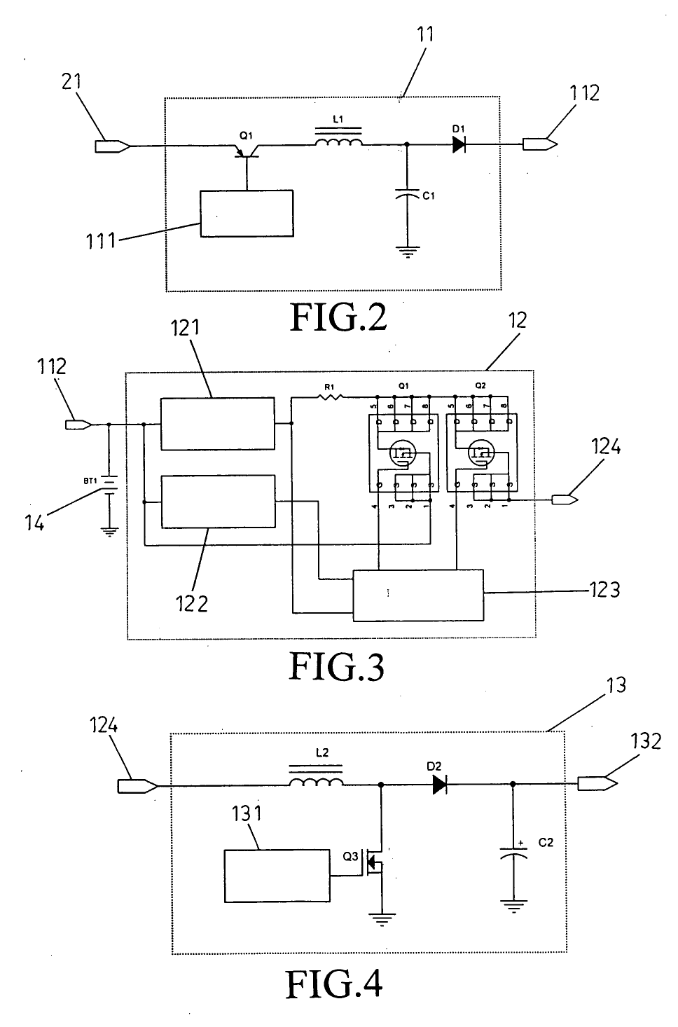

Referring to FIG. 3, inside the test circuit 12 is a detecting circuit 121, which can detect a battery over voltage; and a checking, stabilizing and indicator circuit 122 for the charge level of the battery; as well as a circuit brake 123. The battery charging voltage output 112 goes through the test circuit 12 and then, where running out from a battery status-detected output 124.

Referring to FIG. 1 and FIG. 4, when the battery status-detected output 124 goes through the voltage increase circuit 13, wherein holding a control circuit 131, then an end output 132 reaches out to the peripheral 3, allowing needs for power supply being thereby fulfilled.

It is of course to be understood that the embodiments described herein are merely illustrative of the principles of the invention and that a wide variety of modifications thereto may be effected by persons skilled in the art without departing from the spirit and scope of the invention as set forth in the following claims.

1. A mouse pad with an uninterrupted DC supply comprising:
at leaser one battery charging circuit;
at least one test circuit;
at least one voltage increase circuit;
at least one rechargeable battery; one end of the mouse pad being connected to an AC/DC power converter, the other end thereof being open to compatible peripheral products; when city-power supply is normal the AC/DC power converter charge the battery of the mouse pad therein, simultaneously supplying power to connected peripheral thereof; in case of city power cutoff, the mouse pad immediately activate the rechargeable battery to supply the needs of connected peripheral.

2. The mouse pad with an uninterrupted DC supply according to claim 1, wherein the battery charging circuit including a voltage-stabilizing charging circuit.

3. The mouse pad with an uninterrupted DC supply according to claim 1, wherein the test circuit including a detecting circuit for detecting over-voltage and over-charge of the battery, a checking, stabilizing and indicator circuit for the battery's charge level and a circuit brake.

4. The mouse pad with an uninterrupted DC supply according to claim 1, wherein the voltage increase circuit including a control circuit.

5. The mouse pad with an uninterrupted DC supply according to claim 1, wherein, the compatible products are notebook or desktop computers.
